(19) United States
(12) Patent Application Publication
(10) Pub. No.: US 2010/0267392 A1
(43) Pub. Date: Oct. 21, 2010

(54) REDUCTION OF CALL SET-UP TIME IN MOBILE TERMINATING CALLS WITH "HOME AREA" RATES IN A LAND MOBILE NETWORK

(76) Inventors: Peter Jessen, Bonn (DE); Gerrit Vöhringer, Bonn (DE); Lars Paetel, Bad Honnef (DE)

Correspondence Address: Law Offices of Robert F. Zielinski, LLC, 1518 Walnut Street, Suite 1706, Philadelphia, PA, 19102, US

(21) Appl. No.: 12/741,545

(22) PCT Filed: Sep. 23, 2008
(86) PCT No.: PCT/EP08/08051

§ 371 Date: May 5, 2010

(30) Foreign Application Priority Data
Nov. 8, 2007 (DE) 102007053158.5

(51) Int. Cl. H04W 72/04

(52) U.S. Cl. 455/450

(57) ABSTRACT

The invention relates to a method for setting up a mobile radio connection to a mobile station (MS) in a cellular mobile radio network. According to said method, each cell of the mobile radio network can be identified by an identification character and a plurality of cells form a localisation area of the mobile radio network. In order to localise the mobile station (MS) inside a localisation area, paging is regularly carried out from a switching centre (MSC) in pre-definable time intervals, and a first mobile radio connection to the mobile station (MS) is set up by the paging, whereupon a paging response message is generated from the mobile station (MS) and transmitted over the existing first radio connection. When the paging response message is received, said first mobile radio connection to the mobile station (MS) from the mobile switching centre (MSC) is maintained for a pre-determinable time span, said first mobile radio connection between the mobile switching centre (MSC) and the mobile station (MS) being used to set up a mobile terminating call (MTC) when a call setup from or to the mobile station (MS) is triggered within the time span from the reception of the paging response message.

The invention relates to a method for setting up a cellular connection to a mobile station within a cellular land mobile network in which each cell of the land mobile network can be identified using an identifier, several cells forming a tracking region of the land mobile network, for tracking of the mobile station within a tracking region paging taking place proceeding from a mobile switching center and a first cellular connection to the mobile station being set up by the paging, whereupon a response message is generated on the side of the mobile station and is transmitted via the existing first wireless connection.

Within the framework of introducing fixed mobile conversion services, services from the classic domain of fixed network telephony are also offered in mobile wireless. A service is the use of the cellphone at fixed network process in a defined home area domain. This home area domain is predefined by one or even more cells in the land mobile network. With a comparison of the current position of the cellular customer and the defined home area domain it can be determined whether a favorable fixed network rate or a cellular rate is billed to the customer.

In a call to a cellular customer in the home area domain it is additionally possible to also use a fixed network number instead of the mobile number. If the cellular customer is located in his home area domain, the calling customer can then be billed likewise at the more favorable fixed network rate.

Services of this type are implemented in mobile wireless by means of IN services in an external service creation point (SCP) or in an IN-SSP in a MSC, i.e. a mobile switching center.

For home area rates in the land mobile network it must be determined whether the customer is currently in the home area domain, i.e. within predefinable cells of the cellular land mobile network. This is necessary to ensure that the reduced call minutes are billed to the customer only in this justified case.

A mobile terminated call (MTC) is a call within a telephone network in which the destination terminal is a mobile phone. The opposite term in which the calling terminal is a mobile phone is called a mobile originated call (MOC).

In a mobile originating call (MOC) the current position is concomitantly delivered in the connection set-up so that the relevant rate can be determined from a data comparison of the current cell and the stored home area cells.

In a mobile terminating call (MTC) it is necessary by means of an any time integration (ATI)/provide subscriber info (PSI) procedure to obtain first the current position so that the corresponding rate can be determined. Then the normal MTC connection set-up takes place. In the two procedures which follow one another closely in time (ATI/PSI and MTC) a connection to the mobile phone is set up twice (paging); this means a connection set-up 2-3 seconds longer.

To determine the current cell of the mobile customer the IN-SSP INAP or CAMEL and MAP procedures any time interrogation (ATI) and provide subscriber info (PSI) are used. These two procedures lead to paging on the A or Iu Cs interface of the MSC in the radio access direction (BSC/RNC). With a paging response message (answer message) from the mobile station the current cell of the mobile customer is returned. The paging procedure can last 2-3 seconds depending on the implementation in the radio access and in the mobile station. With the current cell it is then evaluated by means of an IN service in the SCP whether a fixed network rate or a mobile rate is calculated.

After determining the current cell, a normal MTC is carried out according to GSM/3GPP specifications by the IN service in the SCP/IN-SSP. In this MTC in turn paging to the mobile phone is carried out; this then likewise requires 2-3 seconds. These two pagings take place immediately in succession and prolong the call set-up by 2-3 seconds. In addition, the signalling channel on the air interface is likewise occupied longer in this time interval.

In the known methods it is necessary that prepaging is done before the actual connection set-up for the home area services. This is necessary in order to determine the current position of the customer when the mobile terminating call is being set up.

After this pre-paging procedure it can be decided whether the customer is staying in the home area domain or not. In the further connection set-up a second paging is necessary to set up the traffic channel between the MSC and the radio access. This double paging requires unnecessary time and thus call set-up to the mobile customer is unnecessarily prolonged.

The object of the invention is to develop a method for setting up a cellular connection to a mobile station within a cellular land mobile network such that the time which is required for connection set-up within the land mobile network is reduced.

This object is achieved as claimed in the invention by a method as claimed in claim 1.

In the method for setting up a cellular connection to a mobile station (MS) within a cellular land mobile network in which each cell of the land mobile network can be identified using an identifier, several cells forming a tracking region of the land mobile network, for tracking of the mobile station (MS) within a tracking region pagings generally taking place proceeding from a mobile switching center (MSC) within definable intervals and a first cellular connection to the mobile station (MS) being set up by the paging, whereupon a response message is generated on the side of the mobile station (MS) and is transmitted via the existing first wireless connection, it is especially advantageous that when a response message is received this first cellular connection to the mobile station (MS) is held by the mobile switching center (MSC) for a definable time interval, this first cellular connection which exists between the mobile switching center (MSC) and the mobile station (MS) being used for setting up a mobile terminating call (MTC) when a call set-up is triggered from or to the mobile station (MS) within the time interval since receiving a response message.

Because a cellular connection which has already been set up within the framework of paging for call set-up in a mobile terminal call (MTC), i.e. a call within a land mobile network in which the destination terminal is a mobile phone, the time required for call set-up is distinctly reduced [sic].

Thus, with the invention two procedures (PSI and MTC) are used in combination; this means that connection set-up can be reduced by 2-3 seconds and the occupancy of the signalling channel on the air interface is likewise reduced by this time interval.

Advantageous developments of the method as claimed in the invention are given in the dependent claims.

Preferably when a response message of the mobile station is received, a timer function is started for monitoring the time interval since the confirmation message was received.

The first cellular connection can be triggered after the time interval has expired. i.e. that the existing cellar connection to the mobile station is ended when the defined time interval has expired without the call having been set up for a mobile terminating call (MTC).

Especially preferably the cellular connection is charged depending on the geographic position of the mobile station (MS) within the land mobile network by its being distinguished at least between the position of the mobile station (MS) within or outside one or more definable cells of the land mobile network, i.e. that using the position identification which is transmitted and detected within the framework of paging, differentiation takes place between the position of the mobile station within a home area which is defined by definable cells, or outside of this home area, and accordingly billing takes place based on the used [sic].

Preferably the time interval is 1 sec to 5 sec, i.e. that the time interval can be administered in the range from 1 sec to 5 sec.

In one preferred embodiment of the method as claimed in the invention, when the time interval is exceeded before a call setup, repeated paging takes place proceeding from a mobile switching center (MSC), whereupon a response message is generated and transmitted again on the side of the mobile station (MS).

In particular, correct assignment or tracking is ensured within or outside a definable home area since it could have been entered or left after a certain time interval.

Preferably the time interval since receiving a response message on the side of the mobile station (MS) in the mobile switching center (MSC) is monitored by means of a clock function or timer function.

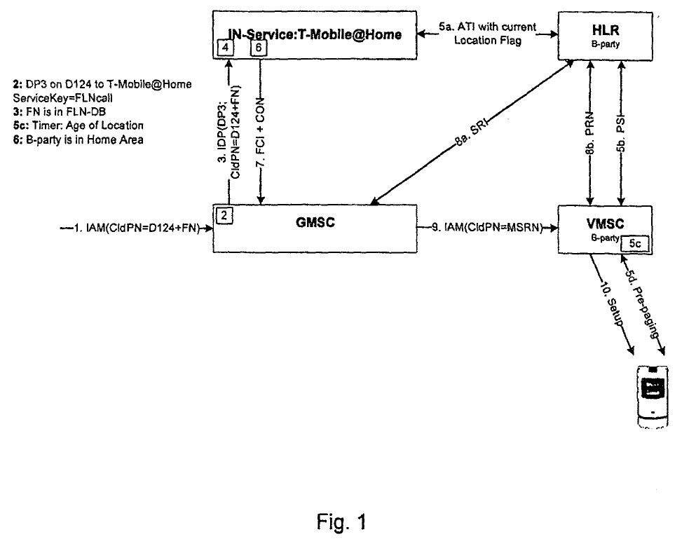

One exemplary embodiment is shown in FIG. 1 and is explained below. FIG. 1 schematically shows the signalling according to the method as claimed in the invention.

A timer (timer function) is started by means of software implementation in the mobile switching center MSC/IN-SSP after reception of the PSI message in the MSC and sending of the paging message. The radio resource, i.e. the existing wireless connection, is not triggered after receiving the paging response message from the mobile and can be used in this way for the following MTC (mobile terminating call, i.e. a call within the land mobile network, in which the destination device is a mobile station). The radio resource is then either triggered by the MTC or, if the MTC does not take place, at latest after the timer runs down. This timer can be administered for example in the range of 1-5 seconds.

Due to this new implementation in the MSC/IN-SPP, a second set-up of the radio resource is no longer necessary since the subsequent MTC can use the already existing radio connection.

The connection set-up is reduced by roughly 2-3 seconds and in addition the radio resource is occupied on average for a shorter time.

This signalling as claimed in the invention and the SW implementation in the MSC/IN-SSP is shown in FIG. 1.

The method as claimed in the invention makes it possible to use the already existing radio resource on the A or Iu Ca interface to the BSS/RNC for paging of the subsequent MTC and in this way to perceptibly reduce the time required for a connection set-up.

After receiving the PSI message with the current cell information, the age of the cell information is compared to an administrable value. If the age is higher, a pre-paging procedure is started. After a successful paging procedure the radio resource on the A or Iu Cs interface is not triggered.

Instead, this radio resource is used for the subsequent incoming connection set-up. After receiving the paging response message, an administrable timer in the MSC is started and the SCCP connection (paging response) is confirmed with an empty connection confirm (CC) message. When the IAM message is received for the subsequent MTC the timer is stopped again. If the timer runs out before the IAM message enters, the content of the paging response is erased and the still existing SCCP connection to the radio access is triggered.

A detailed signalling description of the radio interface is shown by the following table:

| MS | | BTS | | BSC | | MSC | |
|---|---|---|---|---|---|---|---|
| | ← Paging Request | | ← Paging Command | | ← Paging | T-Start | ← PSI |
| | Channel Request → | | Channel Required → | | | | |
| | | | ← Channel Activation | SDCCH | | | |
| | | | | busy | | | |
| | | | Channel Activation Ack → | | | | |
| | ← Immediate Assignment | | ← Immediate Assignment | | | | |
| | | | Command | | | | |
| | SABM (Paging Response) | | Paging Response → | | CR (Paging | | |
| | → | | | | Response) → | | |
| | ← UA (Paging Response) | | | | | | |
| | | | | | ← CC | | |
| | ← Cipher Mode Command | | ← Encryption Information | | ← DT1 (Ciphering | T-IAM = | ← IAM |
| | | | (Cipher Mode Command) | | Mode Command) | T-First | |
| | | | | | | message | |
| | | | | | ← DT1 (Release) | Only in | |
| | | | | | and further release | case | |
| | | | | | messages according | timer | |
| | | | | | GSM/3GPP | expired | |
| | | | | | | in MSC | |

Abbreviations:
MS Mobile station
BTS Base transceiver station
BSC Base station controller
MSC Mobile switching center

1. A method for setting up a cellular connection to a mobile station (MS) within a cellular land mobile network, in which each cell of the land mobile network can be identified using an identifier, several cells forming a tracking region of the land mobile network, for tracking of the mobile station (MS) within a tracking region pagings proceeding from a mobile switching center (MSC) generally taking place within definable intervals and a first cellular connection to the mobile station (MS) being set up by the paging, whereupon a response message is generated on the side of the mobile station (MS) and is transmitted via the existing first wireless connection, characterized in that when a response message is received this first cellular connection to the mobile station (MS) is held by the mobile switching center (MSC) for a definable time interval, this first cellular connection which exists between the mobile switching center (MSC) and the mobile station (MS) being used for setting up a mobile terminating call (MTC) when call set-up is triggered from or to the mobile station (MS) within the time interval since receiving a response message.

2. A method as claimed in claim 1, wherein when a response message of the mobile station is received, a timer function is started for monitoring the time interval since the confirmation message was received.

3. A method as claimed in claim 1, wherein the first cellular connection is triggered after the time interval has expired.

4. A method as claimed in claim 1, wherein the cellular connection is charged depending on the geographic position of the mobile station (MS) within the land mobile network by its being distinguished at least between the position of the mobile station (MS) within or outside one or more definable cells of the land mobile network.

5. A method as claimed in claim 1, wherein the time interval is 1 sec to 5 sec.

6. A method as claimed in claim 1, wherein when the time interval is exceeded before a call setup, repeated paging proceeding from a mobile switching center (MSC) takes place, whereupon a response message is generated and transmitted again on the side of the mobile station (MS).

7. A method as claimed in claim 1, wherein the time interval since receiving a response message on the side of the mobile station (MS) in the mobile switching center (MSC) is monitored by means of a clock function.

8. A method as claimed in claim 2, wherein the first cellular connection is triggered after the time interval has expired.

9. A method as claimed in claim 2, wherein the cellular connection is charged depending on the geographic position of the mobile station (MS) within the land mobile network by its being distinguished at least between the position of the mobile station (MS) within or outside one or more definable cells of the land mobile network.

10. A method as claimed in claim 2, wherein the time interval is 1 sec to 5 sec.

11. A method as claimed in claim 2, wherein when the time interval is exceeded before a call setup, repeated paging proceeding from a mobile switching center (MSC) takes place, whereupon a response message is generated and transmitted again on the side of the mobile station (MS).

12. A method as claimed in claim 2, wherein the time interval since receiving a response message on the side of the mobile station (MS) in the mobile switching center (MSC) is monitored by means of a clock function.
